(19) United States
(12) Patent Application Publication
(10) Pub. No.: US 2018/0295017 A1
(43) Pub. Date: Oct. 11, 2018

(54) DYNAMIC INTERFACE IDENTIFICATION AND CONFIGURATION

(71) Applicant: FUJITSU LIMITED, Kawasaki-shi Kanagawa (JP)

(72) Inventors: Andrew Mao, Sachse, TX (US); Melvin Tan, Richardson, TX (US); William Eugene Beesley, Murphy, TX (US)

(73) Assignee: FUJITSU LIMITED, Kawasaki-shi Kanagawa (JP)

(21) Appl. No.: 15/484,589

(22) Filed: Apr. 11, 2017

(51) Int. Cl. H04L 12/24; H04L 29/12; H04L 12/26; H04L 29/06

(52) U.S. Cl. CPC H04L 41/082; H04L 61/2015; H04L 43/0811; H04L 63/0272; H04L 41/12; H04L 63/10; H04L 41/0886

(57) ABSTRACT

Methods for performing dynamic interface identification and configuration are disclosed. The method may include assessing multiple configurable ports of a computing device to determine which ports are active and whether they are client-facing or network-facing. This may include sending a discovery message or a security protocol message to a network target to see if the target responds. The method may be performed by a dynamic interface manager executing on the computing device. The dynamic interface manager may configure a single active network-facing port as the only network interface for the device and may configure other active ports as client interfaces. The dynamic interface manager may enable internal connections between the network interface and the client interfaces. The dynamic interface manager may reassess the ports in response to connection changes, which may result in a different port being configured as the only network interface for the device.

### BACKGROUND

### Field of the Disclosure

The present disclosure relates generally to network connected devices and, more particularly, to systems and methods for performing dynamic interface identification and configuration.

### Description of the Related Art

Computing devices residing at a customer or end user's premises are becoming increasingly more complicated. For example, in addition to desktop computers, laptop computers, tablet computers, and smart phones, there are many other types of devices that allow customers and end users to connect to the Internet or to specific network locations. These include routers, switches, media players, game consoles, Internet appliances, and commercial or industrial appliances that connect to a network to perform certain functions.

It is not uncommon to see such devices that are implemented as virtual devices running within virtual machines, or that are wrapped within generic packages. White boxes, which do not have a fixed personality or functionality, but can be reprogrammed to behave different or perform different functions, are becoming more desirable and common. Most of these devices statically associate a given interface with a specific function, and each interface is fixed to a particular purpose. For example, some existing devices recognize interfaces based on machine access control (MAC) addresses and fix the identities of their interfaces based on those MAC address.

When these devices include configurable ports, it can be difficult to know which interfaces or ports are network-facing and which are client-facing. In existing devices with configurable ports, the identity of the ports as being network-facing or client-facing can be changed only if software profiles are modified on the device or if hardware within the device is inserted, modified, or removed. Some of these devices provide a user interface through which a human user can enter information to tell the device which port is meant to provide internet access and which port is meant to be used by an internal network, for example.

### SUMMARY

In one aspect, a disclosed method is for dynamic interface identification and configuration. The method may include, in a computing device comprising a processor and a plurality of ports, detecting, by the computing device, that a first port of the plurality of ports is an active network-facing port, where each of the plurality of ports is configurable for client interface functionality and is configurable for network interface functionality, at different points in time. The method may also include determining that no other one of the plurality of ports is configured for network interface functionality, and configuring the first port for network interface functionality, in response to the detecting and the determining. The detecting, the determining, and the configuring may be performed automatically by the computing device without human intervention.

In any of the disclosed embodiments, detecting that the first port of the plurality of ports is an active network-facing port may include sending a discovery request message to a network target at a known Internet Protocol (IP) address, and receiving a response message from the network target indicating that the target is operational and is receiving requests.

In any of the disclosed embodiments, detecting that the first port of the plurality of ports is an active network-facing port may include sending a discovery request message to a network target whose IP address is obtained from a dynamic host configuration protocol (DHCP) server, and receiving a response message from the network target indicating that the target is operational and is receiving requests.

In any of the disclosed embodiments, detecting that the first port of the plurality of ports is an active network-facing port may include sending a request message of a secure communication protocol to a network target, and successfully negotiating with the network target to obtain access to the network target.

In any of the disclosed embodiments, detecting that the first port of the plurality of ports is an active network-facing port may include, for each of the plurality of ports, assessing the port to determine whether it is an active port and assessing the port to determine whether it is a network-facing port or a client-facing port, determining, based on the assessments, that one or more of the plurality of ports, including the first port, is an active network-facing port, and selecting the first port for configuring for network interface functionality from among the one or more ports that were determined to be active network-facing ports.

In any of the disclosed embodiments, the method may further include detecting, subsequent to configuring the first port for network interface functionality, that the first port is no longer an active network-facing port, and, for each of the plurality of ports, reassessing the port to determine whether it is an active port, and reassessing the port to determine whether it is a network-facing port or a client-facing port. The method may also include determining, based on the reassessments, that one or more of the plurality of ports, not including the first port, is an active network-facing port, selecting a given port for configuring for network interface functionality from among the one or more ports that were determined to be active network-facing ports, and configuring the given port for network interface functionality.

In any of the disclosed embodiments, the method may further include detecting that a second port of the plurality of ports is an active client-facing port, configuring the second port for client interface functionality, and enabling a connection between the client interface functionality of the second port and the network interface functionality of first port.

In any of the disclosed embodiments, the method may further include detecting that a third port of the plurality of ports is an active client-facing port configuring the second port for client interface functionality, and enabling a connection between the client interface functionality of the third port and the network interface functionality of first port.

In any of the disclosed embodiments, the method may further include detecting, while the first port is configured for network interface functionality, that a second port of the plurality of ports is an active network-facing port, and disabling network interface functionality for the second port.

In any of the disclosed embodiments, at least two ports of the plurality of ports may be of different types, the different types specifying different communication protocols, different physical connections, or different electrical connections.

In any of the disclosed embodiments, the computing device may be a virtual access network device configured to implement, on behalf of a client, a network connection via a service implemented in accordance with a virtualized network function architecture.

In any of the disclosed embodiments, the computing device may be a virtual access network device configured to act as an endpoint for a secure tunnel.

In another aspect, a disclosed non-transitory computer readable medium may store program instructions executable by a processer. When executed by the processor, the program instructions may cause the processor to perform detecting that a first port of a plurality of ports of a computing device is an active network-facing port, where each of the plurality of ports is configurable for client interface functionality and is configurable for network interface functionality, at different points in time, determining that no other one of the plurality of ports is configured for network interface functionality, and configuring the first port for network interface functionality, in response to the detecting and the determining. The detecting, the determining, and the configuring may be performed automatically and without human intervention.

In any of the disclosed embodiments, detecting that the first port of the plurality of ports is an active network-facing port may include sending a discovery request message to a network target at a known Internet Protocol (IP) address or at an IP address obtained from a dynamic host configuration protocol (DHCP) server, and receiving a response message from the network target indicating that the target is operational and is receiving requests.

In any of the disclosed embodiments, detecting that the first port of the plurality of ports is an active network-facing port may include sending a request message of a secure communication protocol to a network target, and successfully negotiating with the network target to obtain access to the network target.

In any of the disclosed embodiments, detecting that the first port of the plurality of ports is an active network-facing port may include, for each of the plurality of ports, assessing the port to determine whether it is an active port and assessing the port to determine whether it is a network-facing port or a client-facing port, determining, based on the assessments, that one or more of the plurality of ports, including the first port, is an active network-facing port, and selecting the first port for configuring for network interface functionality from among the one or more ports that were determined to be active network-facing ports.

In any of the disclosed embodiments, when executed by the processor, the program instructions may further cause the processor to perform detecting that a second port of the plurality of ports is an active client-facing port, configuring the second port for client interface functionality, and enabling a connection between the client interface functionality of the second port and the network interface functionality of first port.

In any of the disclosed embodiments, when executed by the processor, the program instructions may further cause the processor to perform detecting that a third port of the plurality of ports is an active client-facing port configuring the second port for client interface functionality, and enabling a connection between the client interface functionality of the third port and the network interface functionality of first port.

In yet another aspect, a disclosed system may include a plurality of ports, each of which is configurable for client interface functionality and is configurable for network interface functionality, at different points in time, a processor to execute instructions, and a memory storing instructions executable by the processer. When executed by the processor, the instructions may cause the processor to detect that a first port of the plurality of ports is an active network-facing port, to determine that no other one of the plurality of ports is configured for network interface functionality, and to configure the first port for network interface functionality, in response to the detecting and the determining. The detecting, the determining, and the configuring may be performed automatically by the system without human intervention.

In any of the disclosed embodiments, detecting that the first port of the plurality of ports is an active network-facing port may include sending a discovery request message to a network target at a known Internet Protocol (IP) address or at an IP address obtained from a dynamic host configuration protocol (DHCP) server, and receiving a response message from the network target indicating that the target is operational and is receiving requests.

In any of the disclosed embodiments, detecting that the first port of the plurality of ports is an active network-facing port may include, for each of the plurality of ports, assessing the port to determine whether it is an active port and assessing the port to determine whether it is a network-facing port or a client-facing port, determining, based on the assessments, that one or more of the plurality of ports, including the first port, is an active network-facing port, and selecting the first port for configuring for network interface functionality from among the one or more ports that were determined to be active network-facing ports.

In any of the disclosed embodiments, when executed by the processor, the instructions may further cause the processor to perform detecting that a second port of the plurality of ports is an active client-facing port, configuring the second port for client interface functionality, and enabling a connection between the client interface functionality of the second port and the network interface functionality of first port.

### BRIEF DESCRIPTION OF THE DRAWINGS

For a more complete understanding of the present invention and its features and advantages, reference is now made to the following description, taken in conjunction with the accompanying drawings, in which:

FIG. 1 is a flow diagram illustrating selected elements of a method for performing dynamic interface identification and configuration, according to one embodiment;

FIG. 2 is a flow diagram illustrating selected elements of a method for identifying and configuring multiple ports of a computing device, according to one embodiment;

FIG. 3 is a block diagram illustrating selected elements of a system including an example computing device that has multiple configurable ports, according to one embodiment;

FIG. 4 is a block diagram illustrating selected elements of a computing device following dynamic interface identification and configuration, according to one embodiment;

FIG. 5 is a flow diagram illustrating selected elements of a method for managing configurable ports in a multiple port computing device, according to one embodiment; and

FIG. 6 is a block diagram of selected elements of a computing device that performs dynamic interface identification and configuration, according to one embodiment.

### DESCRIPTION OF THE EMBODIMENT(S)

In the following description, details are set forth by way of example to facilitate discussion of the disclosed subject matter. It should be apparent to a person of ordinary skill in the field, however, that the disclosed embodiments are merely examples and are not exhaustive of all possible embodiments.

Throughout this disclosure, a hyphenated form of a reference numeral refers to a specific instance of an element and the un-hyphenated form of the reference numeral refers to the element generically or collectively. Thus, as an example (not shown in the drawings), widget “12-1” refers to an instance of a widget class, which may be referred to collectively as widgets “12” and any one of which may be referred to generically as a widget “12”. In the figures and the description, like numerals are intended to represent like elements.

As will be described herein, instead of fixing the identity of each port, the multiple port computing devices described herein may employ a method to cycle through all available ports and identify their respective usage as a client interface or as a network interface. For example, these computing devices may include or support many interfaces, e.g., Ethernet ports (RJ45), universal serial bus (USB) ports, or small form-factor pluggable (SFP) interfaces, among others. These computing devices may also be configured with many different profiles to connect to various networks. Other hardware devices may be connected to or disconnected from the computing devices dynamically, after which some port assignments may change.

Since functionality is not prefixed to a specific port; the customer or end user may use any of the interfaces to connect to a particular network. The computing device may dynamically assign functionality to the interfaces, e.g., determining which port will be configured as the only port having network interface functionality for the device and which port (or ports) will be configured for client interface functionality. In some embodiments, this dynamic assignment may be performed through the use of discovery messages, such as pings, or using a Dynamic Host Configuration Protocol (DHCP) server.

In various embodiments, the multiple port computing devices described herein as being enabled to perform dynamic interface identification and configuration may include routers, switches, media players, game consoles, Internet appliances, or commercial or industrial appliances that connect to a network to perform certain functions. In one embodiment, the computing device may be a “Virtual Access Network” (vAN) device that resides at a customer site and provides a network connection via a virtual service (e.g., a service implemented by, or in accordance with, a virtualized network function, or VNF, architecture). The vAN device may act as an endpoint for a secure tunnel using, for example, a tunnel according to an Internet Protocol security (IPsec) Layer 2 Tunneling Protocol (L2TP).

In one example embodiment, a multiple port computing device might act as a tunnel for a virtual private network (VPN) connection for some period of time or under certain scenarios. At another point in time, or under another scenario, the multiple port computing device may be reprogrammed as a pass-through tunnel to pass and/or translate traffic that is going to a network. Instead of always configuring a particular one of the ports for network interface functionality, the device may perform dynamic interface identification and configuration, as described herein.

By enabling the computing devices described herein to perform dynamic interface identification and configuration, these devices may dynamically configure and reconfigure themselves, mapping and remapping interface functionality independently, automatically, and without human intervention. For example, functionality may be assigned to interfaces dynamically without requiring a user to login to (or otherwise interact with) the device to delete previous configurations and setup new configurations. As described in more detail herein, these computing devices may automatically and independently determine the behavior and functionality of each of multiple ports without needing to know the port type or the underlying transport technology that is supported by the port, and without needing to know how many ports there are on the computing device.

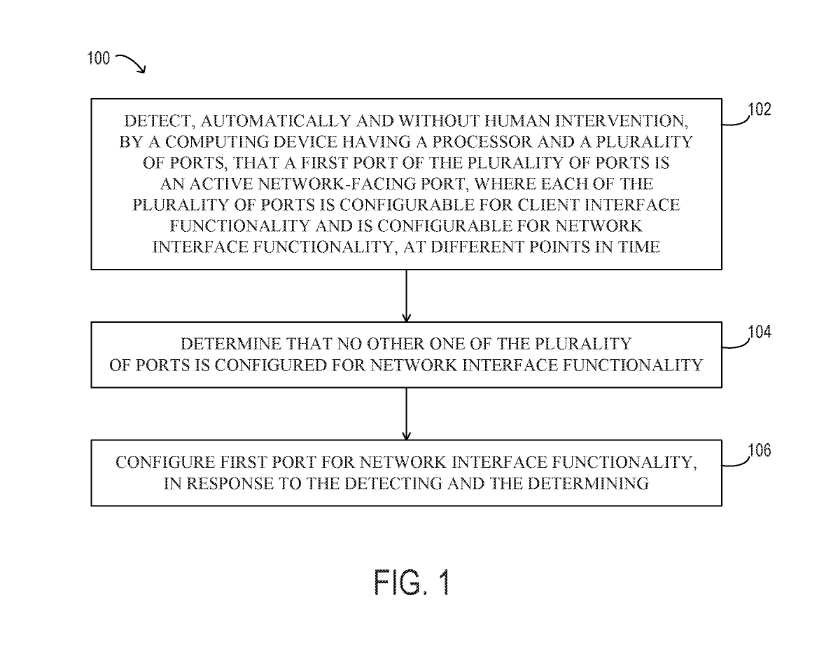

Turning now to the drawings, FIG. 1 is a flow diagram illustrating selected elements of a method 100 for performing dynamic interface identification and configuration, according to one embodiment. In some embodiments, method 100 may be performed by a dynamic interface manager executing on a computing device that includes multiple configurable ports.

In the example embodiment illustrated in FIG. 1, method 100 includes (at 102) detecting, automatically and without human intervention, by a computing device having a processor and a plurality of ports, that a first port of the plurality of ports is an active network-facing port. Each of the plurality of ports may be configurable for client interface functionality and configurable for network interface functionality, at different points in time. For example, a given port may, for some period of time, and under a particular scenario, be configured as a network interface (i.e., configured for network interface functionality). However, at a different point in time, or under other scenarios, the given port may be reconfigured as a client interface (i.e., configured for client interface functionality).

Method 100 also includes (at 104) determining that no other one of the plurality of ports is configured for network interface functionality. For example, in some embodiments, in order to prevent loops, only one port may be configured as a network interface at a time. Method 100 also includes (at 106) configuring the first port for network interface functionality, in response to detecting that the first port is an active network-facing port and determining that no other port is configured for network interface functionality.

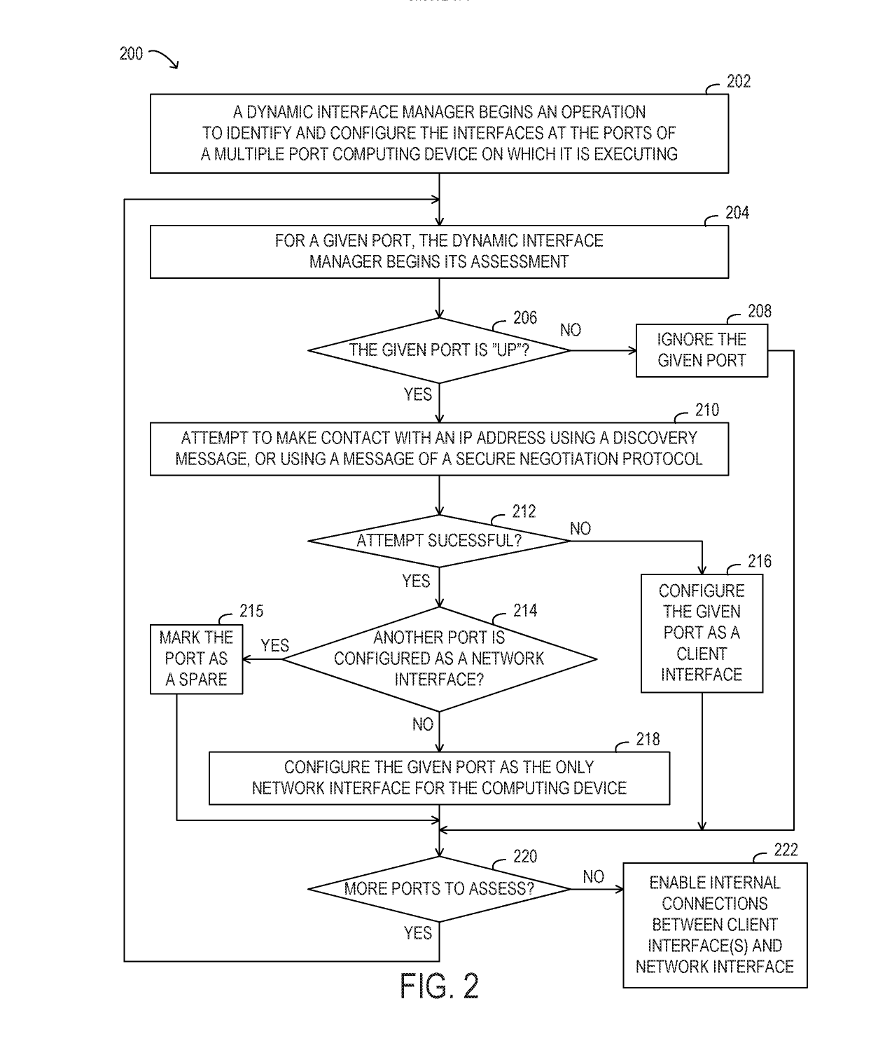

As noted above, the multiple port computing devices described herein may employ a method to cycle through all available ports and identify their respective usage as a client interface or a network interface. FIG. 2 is a flow diagram illustrating selected elements of a method 200 for identifying and configuring multiple ports of a computing device, according to one embodiment. In some embodiments, method 200 may be performed by a dynamic interface manager executing on a computing device that includes multiple configurable ports.

In the example embodiment illustrated in FIG. 2, method 200 includes (at 202) a dynamic interface manager beginning an operation to identify and configure the interfaces at the ports of a multiple port computing device on which it is executing. The method may also include (at 204), for a given port, the dynamic interface manager beginning its assessment. If, at 206, it is determined that the given port is “up”, method 200 may proceed to 210. Otherwise, method 200 may proceed to 208, and the given port may be ignored. Method 200 may then proceed to 220. As used herein, the term “up” may be used to describe a port on which there is not just physical connection (e.g., there is something plugged into the port), but on which an active link has been established. For example, in some embodiments, the connection at a given port may be considered “up” if and when it has successfully negotiated with an entity at the other end of the connection and is ready to pass traffic through that connection. In some embodiments, such as in embodiments in which the given port implements an Ethernet connection, this may include an automatic negotiation of the duplex mode and speed for the connection and/or any other configurable transmission parameters for the connection.

Method 200 may include (at 210) attempting to make contact with a network target at a particular IP address using a discovery message (such as a ping), or using a message of a secure negotiation protocol. In some embodiments, the IP address may be a known IP address for a network target of the type that, if the device is able to reach and response a response from the network target through the given port, this would indicate that the given port is an active network-facing port. In some embodiments, a known IP address may be hard coded in the device. In other embodiments, the IP address may be an IP address obtained from a dynamic host configuration protocol (DHCP) server. In some embodiments, the IP address may be discovered dynamically through a name, and after connecting to a named DHCP server, the server may supply the appropriate IP address for the network target to which the attempt to make contact is directed.

In certain scenarios, a simple ping may be easily mimicked or may be unreliable. Therefore, in some embodiments, the ping message may be replaced with a secure negotiation such as a certification check, key exchange, or user/password authentication. This approach may help guarantee the correct identity of the client/network. When a secure exchange is employed, the assessment performed by the computing device may not just depend on the fact that a particular IP address is discoverable, or can be connected to, but also on this secure negotiation. For example, in some embodiments, the computing device may send a message of a secure protocol which, when received at the target will open up a negotiation to determine if the target is the correct target and if the computing device is authorized to connect to the target. If the negotiation is successful, the given port may be configured as a network interface. In some cases, subsequent to this negotiation, a separate client authentication may also be required before a client is able to access the target.

If (at 212) the attempt is successful, method 200 may proceed to 214. Otherwise, method 200 may proceed to 216, where the given port is configured as a client interface, after which the method may proceed to 220. In some embodiments, identifying a port as a client-facing port may include determining the direction of the communication at the port with respect to the computing device, e.g., determining whether it is an input-only interface, an out-only interface, or an input-output interface. If (at 214) it is determined that another port is already configured as a network interface, method 200 may proceed to 215. The method may include (at 215) marking the given port as a spare network-facing port, after which the method may proceed to 220. Otherwise, method 200 may proceed to 218. Method 200 may include (at 218) configuring the given port as the only network interface for the computing device.

If (at 220) there are no additional ports to be assessed, method 200 may proceed to 222, where the method includes enabling internal connections between any ports configured as client interfaces and the single port configured as a network interface. Otherwise, method 200 may return to 204 and may repeat some or all of the operations illustrated as 204-218, as appropriate, for each additional port. Once all of the ports of the computing device have been assessed, the method may include enabling internal connections between any ports configured as client interfaces and the single port configured as a network interface (as in 222).

In the example embodiment illustrated in FIG. 2, method 200 includes configuring the first active network-facing port that is encountered during the assessment as the only network interface for the computing device. In other embodiments, a dynamic interface manager may select one of multiple active network-facing ports to be configured as the only network interface for the computing device based on different criteria regardless of the order in which the active network-facing ports are identified. For example, the dynamic interface manager may apply a fixed or configurable priority scheme to the selection of the active network-facing port that is to be configured as the only network interface for the computing device. In some embodiments, a single port may be designated as a default or highest priority port for configuration as the only network interface, if it is available for such configuration. In other embodiments, relative priories may be assigned to multiple ones of the configurable ports of the computing device indicting which port, if available for configuration, should be selected for configuration as the only network interface over other available active network-facing ports. In one specific example, a port that implements an Ethernet connection may be prioritized for configuration as the only network interface of the computing device over a port that implements a USB long-term evolution (LTE) standard for high-speed wireless communication because wireless bandwidth is generally more expensive to use.

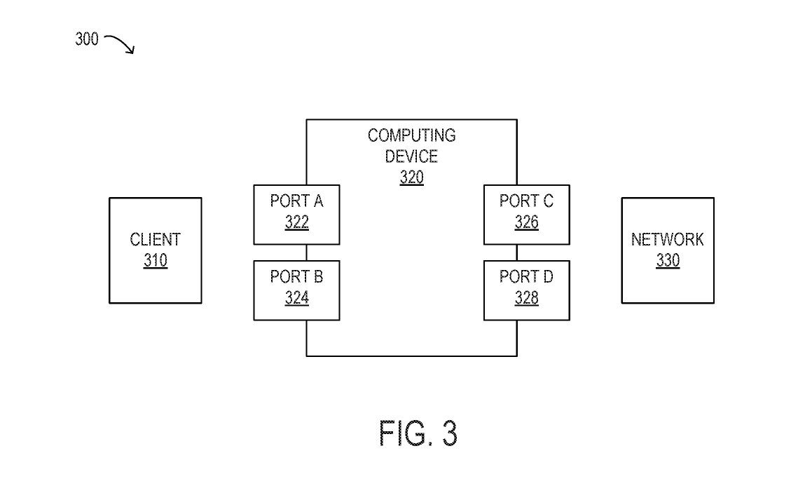

FIG. 3 is a block diagram illustrating selected elements of a system 300 including an example computing device that has multiple configurable ports, according to one embodiment. In this example, system 300 includes at least one client 310, a computing device 320 that is enabled to perform dynamic interface identification and configuration, and a particular network 330 to which computing device is to be coupled. In some embodiments, a server or public IP address may be exposed to the internet to act as a portal or an entry way for a client to gain access into a private network, and it may be this private network that the computing device is to be connected to as network 330. For example, the client may connect to the public IP address in order to negotiate with and establish a secure tunnel to the private network. In this example, the techniques described herein may be used to automatically identify a port that can connect to the secure tunnel.

In this example, computing device 320 includes four ports, shown as port A (322), port B (324), port C (326) and port D (328). At least some of these ports may be dynamically configurable for client interface functionality and/or for network interface functionality, at different points in time. In other words, each configurable port may be configured as a client interface for some period of time, after which it may be reconfigured as a network interface, and vice versa. In some embodiments, all of ports 322-328 may be ports of the same type, in terms of their physical and electrical connections and/or in terms of the communication protocols they support. In other embodiments, ports 322-328 may include ports of two or more different types, the different types specifying different physical connections, different electrical connections, and/or different communication protocols. For example, the computing device may include one or more Ethernet ports, USB ports (through which various USB devices such as WiFi dongles, LTE dongles, or USB-to-Gigabit-Ethernet adapters can be connected to the computing device), or small form-factor pluggable (SFP) interfaces, among others, in different combinations. In one example embodiment, computing device 320 may be a virtual access network device that includes two Ethernet ports (RJ45s), an SFP cage in which to insert an SFP, and two USB3 ports. In another example embodiment, computing device 320 may be a virtual access network device that includes only one Ethernet port (RJ45) instead of two, and includes one USB2 port instead of two USB3 ports. In another embodiment, computing device 320 may be a virtual access network device that includes two Ethernet ports (RJ45s), an SFP cage in which to insert an SFP, and a USB port into which an LTE modem is connected. In yet another example embodiment, computing device 320 may be a router box that includes multiple ports, all of which are the same type, e.g., ten Ethernet ports (RJ45s).

In this example, computing device 320 may perform an initial assessment of ports 322-328 to identify which of the ports is an active network-facing port and to configure a single one of such ports (if multiple such ports are identified) as the only network interface for computing device 320. In at least some embodiments, the assessment may be performed by a dynamic interface manager executing on computing device 320 in accordance with method 100 illustrated in FIG. 1 and method 200 illustrated in FIG. 2, both of which are described above. Configuring the single port as the only network interface for computing device 320 may include coupling the single port to network 330 to allow communication between computing device 320 and network 330. Ports identified as active client-facing ports, as well as any additional ports identified as active network-facing ports, may be configured (or at least marked) as client interfaces. Configuring a port as a client interface may include coupling the port to a client 310 to allow communication between computing device 320 and the client 310. Subsequent to the assessment and the configuration of a single network interface and one or more client interfaces, internal connections between the port configured for network interface functionality and one or more ports configured for client interface functionality may be enabled within computing device 320 to allow the client(s) 310 to reach network 330. In some embodiments, these internal connections may include various electrical switches to allow different combinations of ports (and interfaces thereof) to be connected to each other. In other embodiments, these internal connections may include a bridge to connect a client interface to the network interface. In some embodiments, only a single client interface exists and this client may be connected to the single network interface through the internal connections. In other embodiments, multiple client interfaces, if they exist, may be connected to the single network interface through the internal connections. In various embodiments, the internal connection between a network interface and a client interface may be implemented using any type of connection supported by the particular interfaces for which the corresponding ports are configured. This may include, but is not limited to, a Layer 2 (L2) communication connection, a Layer 3 (L3) communication connection, an L2 tunnel, or an IPsec tunnel.

Note that while computing device 320 illustrated FIG. 3 includes four configurable ports, in other embodiments, a computing device configured to perform dynamic interface identification and configuration may include more or fewer ports, any ones of which may be of the same of different port types, in various combinations.

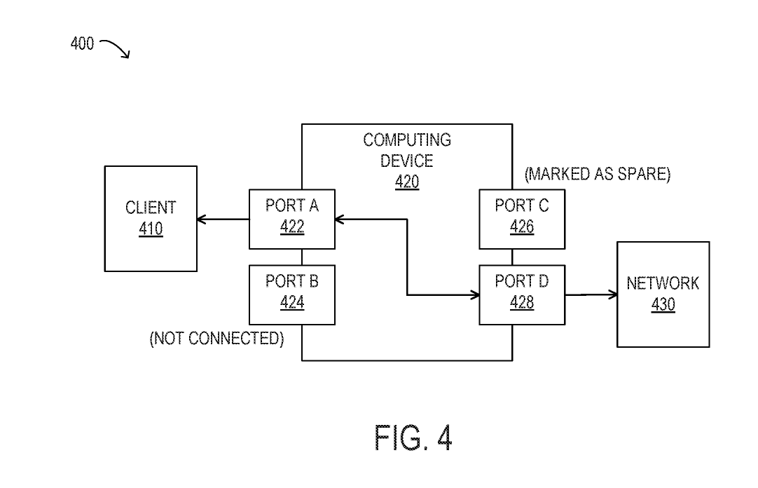

FIG. 4 is a block diagram illustrating selected elements of a system 400, including an example computing device 420 that has multiple configurable ports, following dynamic interface identification and configuration, according to one embodiment. Computing device 420 may be similar to computing device 320 illustrated in FIG. 3 or may be configured differently than computing device 320, in different embodiments. In the example illustrated in FIG. 4, computing device 420 includes four configurable ports, shown as port A (422), port B (424), port C (426), and port D (428).

In this example, following an operation to identify and configure the interfaces of computing device 420, port D (428) has been identified as an active network-facing port and has been configured as a network interface in order to communicate with network 430. In this example, port C (426) has also been identified as an active network-facing port. However, because port D (428) was selected for configuring for network interface functionality, port C (426) has been marked as a spare network-facing port. In other embodiments, an active network-facing port that is not selected for configuring as a network interface may not be marked as a spare network-facing port, but may be ignored. In some embodiments, any circuitry to configure port C for network interface functionality may be disabled.

In this example, port B (424), which is not connected to any other device or communication link (such as a cable), is ignored for the purposes of network interface identification and configuration. Port A (422) has been identified as an active client-facing port and has been configured as a client interface for communicating with client 410.

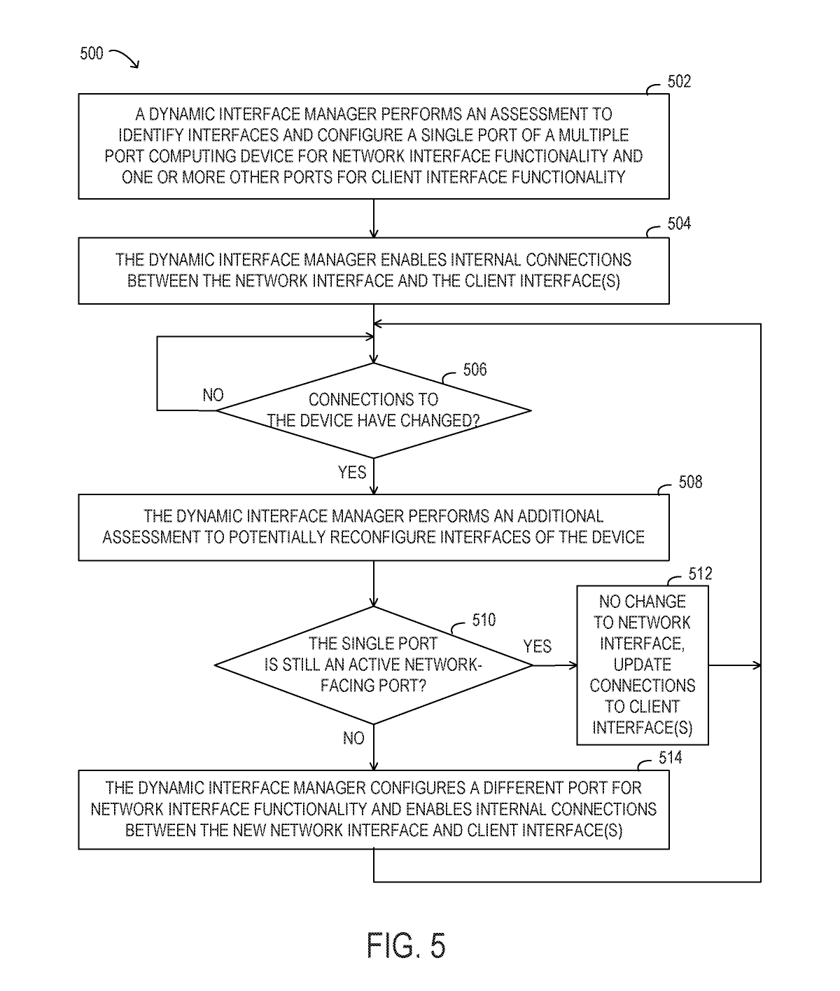

Subsequent to configuring the ports of computing device 420 as illustrated in FIG. 4, the dynamic interface manager may reconfigure one or more of the ports in response to changing conditions, such as changes to the connections to any of the ports 422-428 of computing device 420. One example of a method for performing such reconfigurations is illustrated in FIG. 5 and described below.

FIG. 5 is a flow diagram illustrating selected elements of a method 500 for managing configurable ports in a multiple port computing device, according to one embodiment.

In some embodiments, method 500 may be performed by a dynamic interface manager executing on a computing device that includes multiple configurable ports.

In the example embodiment illustrated in FIG. 5, method 500 includes (at 502) a dynamic interface manager performing an assessment to identify interfaces and configure a single port of a multiple port computing device for network interface functionality and one or more other ports for client interface functionality, as described herein. The method may include (at 504) the dynamic interface manager enabling internal connections between the network interface and the client interface(s), in response to the assessment.

While (at 508) there are no changes to any of the connections to the device, method 500 may include continuing to poll for any changes before proceeding. If, or once, it is determined that there have been changes to the connections to the device, method 500 may proceed to 508. Example of the types of changes that may trigger a reassessment of the ports of the device may include, but are not limited to, a device being connected to one of the ports or disconnected from one of the ports that is configured for client interface functionality, a network cable being disconnected from the port that is configured for network interface functionality, or the network connection being lost at the port configured for network interface functionality, what else?). Method 500 may include (at 508) the dynamic interface manager performing an additional assessment to potentially reconfigure interfaces of the device. If (at 510), it is determined, based on the additional assessment, that the single port is no longer an active network-facing port, method 500 may proceed to 514, where it may configure a replacement port as the network interface for the device. Otherwise, method 500 may proceed to 512, where no change is made with respect to the identification of the network interface, but connections between the network interface and any client interfaces may be updated, as appropriate. For example, in the case that another client-facing has been activated, the additional client-facing port may be identified and configured as a client interface by the reassessment and may be connected to the network interface over the bridge.

Method 500 may include (at 514) the dynamic interface manager configuring a different port for network interface functionality and enabling internal connections between the new network interface and the updated client interface(s), after which the method may return to 506. In one example, if the computing device includes an LTE modem through which it connects to the network, but the network connection through the LTE modem is lost, if there is another available network-facing port (e.g., a port having an Ethernet or WiFi connection), the dynamic interface manager may automatically configure one such additional network-facing port as the network interface for the device. In some embodiments, any additional available network-facing ports may have been identified by the dynamic interface manager and marked as spare network-facing ports during a previous assessment of the ports of the computing device. Subsequent to configuring the different port for network interface functionality, if and when any additional changes are made to the connections to the computing device, method 500 may perform any or all of the operations shown as 508-514, as appropriate, in response to those changes.

In some embodiments, the dynamic interface manager may perform assessments of the ports periodically instead of, or in addition to, in response to changes in the connections to the device or other reassessment trigger conditions.

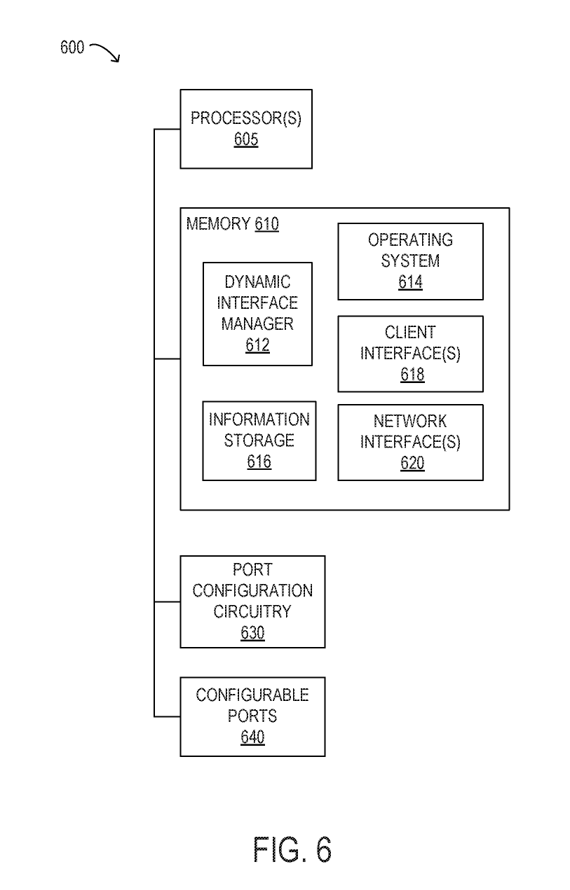

Referring now to FIG. 6, a block diagram of selected elements of a computing device 600 enabled to perform dynamic interface identification and configuration is illustrated, according to one embodiment. In FIG. 6, computing device 600 is represented as a computer system including physical and logical components for implementing any of a variety of computing devices on which dynamic interface identification and configuration may be implemented including, but not limited to, routers, switches, media players, game consoles, Internet appliances, and commercial or industrial appliances that connect to a network to perform certain functions. However, some of these computing devices may not include all of the components illustrated in FIG. 6, in some embodiments. In other embodiments, a computing device enabled to perform dynamic interface identification and configuration, as described herein, may include more, fewer, or different components than those included in the example embodiment illustrated in FIG. 6.

As illustrated in this example, computing device 600 may include one or more processors 605, memory 610, multiple configurable ports 640, and port configuration circuitry 630. At least some of configurable ports 640 may be dynamically configurable for client interface functionality and/or for network interface functionality, at different points in time. In other words, each configurable port 640 may be configured as a client interface for some period of time, after which it may be reconfigured as a network interface, and vice versa. Not illustrated in FIG. 6 are other resources that implement the functionality of computing device 600 other than dynamically identifying and configuring configurable ports 640. Processor 605 may represent one or more individual processing units and may execute program instructions, interpret data, and process data stored by memory 610 or another component within computing device 600 to implement the functionality described herein, in different embodiments.

In FIG. 6, memory 610 may be communicatively coupled to processor 605 and may comprise a system, device, or apparatus suitable to retain program instructions and data for a period of time (e.g., non-transitory computer-readable media). Memory 610 may include various types components and devices, such as random access memory (RAM), electrically erasable programmable read-only memory (EEPROM), a PCMCIA card, flash memory, solid state disks, hard disk drives, magnetic tape libraries, optical disk drives, magneto-optical disk drives, compact disk drives, compact disk arrays, disk array controllers, and/or any suitable selection or array of volatile or non-volatile memory. Non-volatile memory refers to a memory that retains data after power is turned off. It is noted that memory 610 may include different numbers of physical storage devices, in various embodiments.

As shown in FIG. 6, memory 610 may include instructions to implement an operating system 614, and a dynamic interface manager 612. In some embodiments, operating system 614 may, for example, be UNIX or be based on UNIX (e.g., a LINUX variant). In other embodiments, operating system 614 may be one of a number of variants of Microsoft Windows® operating systems, a mobile device operating system (e.g., Google Android™ platform, Apple® iOS, among others), an Apple® MacOS operating system, an embedded operating system, a gaming operating system, or another suitable operating system. Dynamic interface manager 612 may perform operations for identifying and configuring various interfaces of computing system 600 at configurable ports 640, as described herein. For example, in various embodiments, computing device 600 may implement any or all of the elements of method 100 illustrated in FIG. 1, method 200 illustrated in FIG. 2, or method 500 illustrated in FIG. 5, among other functionality. In at least some embodiments, computing device 600 may implement methods 100, 200, or 500 automatically and without human interaction.

In this example embodiment, memory 610 may include program instructions for implementing one or more client interfaces 618, as needed. Memory 610 may also include program instructions for implementing one or more network interfaces 620, as needed. For example, client interfaces 618 may include program instructions for implementing client interface functionality according to a variety of client communication protocols, different ones of which may be supported by the physical and electrical connections at respective ones of the configurable ports 640 dependent on their respective port types. Similarly, network interfaces 620 may include program instructions for implementing network interface functionality according to a variety of network communication protocols, different ones of which may be supported by the physical and electrical connections at respective ones of the configurable ports 640 dependent on their respective port types.

Memory 610 may also include information storage 640, which may store information usable by dynamic interface manager 612 including, but not limited to, mappings between various ones of configurable ports 640 and respective client interfaces 618 or network interfaces 620, data representing the port type for each of the configurable ports 640 (e.g., Ethernet, USB, or small form-factor pluggable (SFP) types, among others), data representing the status of each of configurable ports 640 (e.g., as “not connected”, “connected”, “active”, “client-facing”, or “network-facing”, among other status options), data representing measurements of interface health or performance at each port (such as latency, throughput, percentage of time the port is “up” when connected, communication error rates), or values of any other default or configurable parameters used to implement the functionality described herein or any other functionality of computing device 600.

In the example embodiment illustrated in FIG. 6, port configuration circuitry 630 may include circuitry, logic, and/or program instructions for configuring each active port within configurable ports 640 for network interface functionality or client interface functionality, under the control of dynamic interface manager 612. For example, each of configurable ports 640 may include circuitry to implement client interface functionality in accordance with one or more of client interfaces 618 and circuitry to implement network interface functionality in accordance with one or more of network interfaces 620, but the port can be configured as only one type of interface at a time. When dynamic interface manager 612 determines which of configurable ports 640 are to be configured for client interface functionality and which of configurable ports 640 is to be configured for network interface functionality, dynamic interface manager 612 may generate control signals to cause port configuration circuitry to configure the port according to these determinations. For example, in some embodiments, once dynamic interface manager 612 has determined that a given port is to be configured as a network interface, dynamic interface manager 612 may send a control signal to port configuration circuitry 630 indicating that the given port is to be configured for network interface functionality. In response, port configuration circuitry 630 may disable the circuitry within the given port to implement client interface functionality and enable circuitry within the given port to implement network interface functionality. Conversely, once dynamic interface manager 612 has determined that a given port is to be configured as a client interface, dynamic interface manager 612 may send a control signal to port configuration circuitry 630 indicating that the given port is to be configured for client interface functionality. In response, port configuration circuitry 630 may enable the circuitry within the given port to implement client interface functionality and disable the circuitry within the given port to implement network interface functionality.

In some embodiments, after sending control signals to port configuration circuitry 630 to configure one of configurable ports 640 as a network interface and to configure at least one other one of the configurable ports 640 as a client interface, dynamic interface manager 612 may generate, and send to port configuration circuitry 640, control signals to indicate that the port(s) configured for client interface functionality and the port configured for network interfaces functionality are to be connected internally on computing device

While some of the examples of dynamic interface identification and configuration described herein are directed to computing devices with four ports, in other embodiments, a computing device enabled to perform dynamic interface identification and configuration may include any number of ports of different port types in any suitable combination, at least some of which are configurable ports. In some embodiments, only a subset of the ports of a computing device that is enabled to perform dynamic interface identification and configuration may be configurable while another subset of the ports may be fixed-function ports. In such embodiments, a dynamic interface manager may dynamically determine the interfaces at each of the configurable ports and may use that information and information about the fixed function ports when determine which, if any, of the configurable ports is to be configured as a network interface and which, if any, of the configurable ports are to be configured as client interfaces.

As described in detail herein, a method for performing dynamic interface identification and configuration may include assessing multiple configurable ports of a computing device to determine which ports are active and whether they are client-facing or network-facing. This may include sending a discovery message or a security protocol message to a network target to see if the target responds. The method may be performed by a dynamic interface manager executing on the computing device. The dynamic interface manager may configure a single active network-facing port as the only network interface for the device and may configure other active ports as client interfaces. The dynamic interface manager may enable internal connections between the network interface and the client interfaces. The dynamic interface manager may reassess the ports in response to connection changes, which may result in a different port being configured as the only network interface for the device.

While the subject of this specification has been described in connection with one or more example embodiments, it is not intended to limit any claims to the particular forms set forth. On the contrary, any claims directed to the present disclosure are intended to cover such alternatives, modifications and equivalents as may be included within their spirit and scope.

What is claimed is:

1. A method, comprising, in a computing device comprising a processor and a plurality of ports:
detecting, by the computing device, that a first port of the plurality of ports is an active network-facing port, wherein each of the plurality of ports is configurable for client interface functionality and is configurable for network interface functionality, at different points in time;
determining that no other one of the plurality of ports is configured for network interface functionality; and
configuring the first port for network interface functionality, in response to the detecting and the determining;
wherein the detecting, the determining, and the configuring are performed automatically by the computing device without human intervention.

2. The method of claim 1, wherein detecting that the first port of the plurality of ports is an active network-facing port comprises:
sending a discovery request message to a network target at a known Internet Protocol (IP) address or at an IP address obtained from a dynamic host configuration protocol (DHCP) server; and
receiving a response message from the network target indicating that the target is operational and is receiving requests.

3. The method of claim 1, wherein detecting that the first port of the plurality of ports is an active network-facing port comprises:
sending a request message of a secure communication protocol to a network target; and
successfully negotiating with the network target to obtain access to the network target.

4. The method of claim 1, wherein detecting that the first port of the plurality of ports is an active network-facing port comprises:
for each of the plurality of ports:
assessing the port to determine whether it is an active port; and
assessing the port to determine whether it is a network-facing port or a client-facing port;
determining, based on the assessments, that one or more of the plurality of ports, including the first port, is an active network-facing port; and
selecting the first port for configuring for network interface functionality from among the one or more ports that were determined to be active network-facing ports.

5. The method of claim 4, further comprising:
detecting, subsequent to configuring the first port for network interface functionality, that the first port is no longer an active network-facing port;
for each of the plurality of ports:
reassessing the port to determine whether it is an active port; and
reassessing the port to determine whether it is a network-facing port or a client-facing port;
determining, based on the reassessments, that one or more of the plurality of ports, not including the first port, is an active network-facing port;
selecting a given port for configuring for network interface functionality from among the one or more ports that were determined to be active network-facing ports; and
configuring the given port for network interface functionality.

6. The method of claim 1, further comprising:
detecting that a second port of the plurality of ports is an active client-facing port;
configuring the second port for client interface functionality; and
enabling a connection between the client interface functionality of the second port and the network interface functionality of first port.

7. The method of claim 6, further comprising:
detecting that a third port of the plurality of ports is an active client-facing port configuring the second port for client interface functionality; and
enabling a connection between the client interface functionality of the third port and the network interface functionality of first port.

8. The method of claim 1, further comprising:
detecting, while the first port is configured for network interface functionality, that a second port of the plurality of ports is an active network-facing port; and
disabling network interface functionality for the second port.

9. The method of claim 1, wherein at least two ports of the plurality of ports are of different types, the different types specifying different communication protocols, different physical connections, or different electrical connections.

10. The method of claim 1, wherein the computing device is a virtual access network device configured to implement, on behalf of a client, a network connection via a service implemented in accordance with a virtualized network function architecture.

11. The method of claim 1, wherein the computing device is a virtual access network device configured to act as an endpoint for a secure tunnel.

12. A non-transitory computer readable storage medium, storing program instructions that when executed by one or more processors cause the processors to perform:
detecting that a first port of a plurality of ports of a computing device is an active network-facing port, wherein each of the plurality of ports is configurable for client interface functionality and is configurable for network interface functionality, at different points in time;
determining that no other one of the plurality of ports is configured for network interface functionality; and
configuring the first port for network interface functionality, in response to the detecting and the determining;
wherein the detecting, the determining, and the configuring are performed automatically and without human intervention.

13. The storage medium of claim 12, wherein detecting that the first port of the plurality of ports is an active network-facing port comprises:
sending a discovery request message to a network target at a known Internet Protocol (IP) address or at an IP address obtained from a dynamic host configuration protocol (DHCP) server; and
receiving a response message from the network target indicating that the target is operational and is receiving requests.

14. The storage medium of claim 12, wherein detecting that the first port of the plurality of ports is an active network-facing port comprises:
sending a request message of a secure communication protocol to a network target; and
successfully negotiating with the network target to obtain access to the network target.

15. The storage medium of claim 12, wherein detecting that the first port of the plurality of ports is an active network-facing port comprises:
for each of the plurality of ports:
assessing the port to determine whether it is an active port; and
assessing the port to determine whether it is a network-facing port or a client-facing port;
determining, based on the assessments, that one or more of the plurality of ports, including the first port, is an active network-facing port; and
selecting the first port for configuring for network interface functionality from among the one or more ports that were determined to be active network-facing ports.

16. The storage medium of claim 12, wherein when executed by the processor, the program instructions further cause the processor to perform:
detecting that a second port of the plurality of ports is an active client-facing port;
configuring the second port for client interface functionality; and
enabling a connection between the client interface functionality of the second port and the network interface functionality of first port.

17. A system, comprising:
a plurality of ports, each of which is configurable for client interface functionality and is configurable for network interface functionality, at different points in time;
a processor to execute instructions;
a memory storing instructions that when executed by the processor cause the processor to:
detect that a first port of the plurality of ports is an active network-facing port;
determine that no other one of the plurality of ports is configured for network interface functionality; and
configure the first port for network interface functionality, in response to the detecting and the determining;
wherein the detecting, the determining, and the configuring are performed automatically by the system without human intervention.

18. The system of claim 17, wherein detecting that the first port of the plurality of ports is an active network-facing port comprises:
sending a discovery request message to a network target at a known Internet Protocol (IP) address or at an IP address obtained from a dynamic host configuration protocol (DHCP) server; and
receiving a response message from the network target indicating that the target is operational and is receiving requests.

19. The system of claim 17, wherein detecting that the first port of the plurality of ports is an active network-facing port comprises:
for each of the plurality of ports:
assessing the port to determine whether it is an active port; and
assessing the port to determine whether it is a network-facing port or a client-facing port;
determining, based on the assessments, that one or more of the plurality of ports, including the first port, is an active network-facing port; and
selecting the first port for configuring for network interface functionality from among the one or more ports that were determined to be active network-facing ports.

20. The system of claim 17, wherein when executed by the processor, the instructions further cause the processor to perform:
detecting that a second port of the plurality of ports is an active client-facing port;
configuring the second port for client interface functionality; and
enabling a connection between the client interface functionality of the second port and the network interface functionality of first port.
